(19) United States
(12) Patent Application Publication
(10) Pub. No.: US 2004/0011493 A1
(43) Pub. Date: Jan. 22, 2004

(54) Apparatus having wear-resistant surface and method for making

(75) Inventors: Reginald R. Maas, Newberg, OR (US); Thomas C. Maslen, Hillsboro, OR (US); Dean A. Rulis, Banks, OR (US); Thomas D. Church, Salem, OR (US)

Correspondence Address: KLARQUIST SPARKMAN, LLP, One World Trade Center, Suite 1600, 121 S.W. Salmon Street, Portland, OR, 97204, US

(73) Assignee: CoorsTek, Inc.

(21) Appl. No.: 10/176,964

(22) Filed: Jun. 21, 2002

(51) Int. Cl. D21F 1/18; D21F 1/10; D21F 1/00; B32B 31/26

(52) U.S. Cl. 162/354; 156/307.1; 162/348; 162/356

(57) ABSTRACT

Hardened wear-resistant members are secured to an underlying body member in a manner to accommodate differing coefficients of thermal expansion. In one form a connector comprising shear compliant material is secured at one of its faces to the body member and a hardened wear-resistant member is secured to the opposite face of the connector. In another embodiment, the body member has adjacent portions resiliently connected to each other and the engaging member is secured at spaced locations to the two resiliently joined portions such that different thermal expansion of the two parts will be accommodated.

### FIELD OF THE INVENTION

The present invention pertains to apparatus including a hard wear-resistant member having a first coefficient of thermal expansion mounted on an underlying body member having a different coefficient of thermal expansion, and means for securing the two together to accommodate different rates of expansion and thermal transmission during use.

### BACKGROUND OF THE INVENTION

Often it is desirable to provide hardened wear-resistant members, such as ceramic, for supporting other apparatus or elements movable thereover. Since ceramic elements may be expensive and brittle it is desirable to mount the ceramic members on underlying support, or body, members manufactured of another material. In the past, however, difficulties have arisen, in that the hardened wear-resistant material, such as ceramic, may have a coefficient of thermal expansion different from the underlying support member, and thus during use the members expand and contract at different rates.

In the past wear-resistant members, or elements, have been bonded to the underlying support member by various adhesives applied directly between the two members. The wear-resistant members may be formed in segments and adhered to the underlying support member in edge-abutting relationship. However, during operation differences in thermal expansion or contraction rates between the wear-resistant members and support member eventually caused failure in the adhesive allowing either one or more of the wear-resistant elements to partially or fully separate from the underlying support body causing problems in the movement of materials, or conveyors, thereover. Furthermore direct adhesion of wear resistant members allows rapid heat conduction therethrough into the adhesive layer and support body which can produce misalignment of members. This may cause permanent warpage of the support body and uneven geometry which often is critical in equipment using such elements.

This is particularly a concern in papermaking equipment, for example, wherein a conveyor belt, or web, carrying paper stock moves over foils, or blades, wherein the foils, or blades, include ceramic elements secured to an underlying body member. Should one or more of the ceramic elements release from its securement to the underlying body member it can cause the conveyor to be shifted out of line causing imperfections in the paper stock. This might produce a considerable length of imperfection in the paper stock since the conveyor is running at high rates of speed.

Attempts have been made in the past to more positively lock the hardened wear-resistant element to its underlying support. One such method has included providing dovetail interconnections between the support body and the wear-resistant member. At least two problems arise with such. First, the ceramic element must be made of a thick enough cross section that it can have an indented dovetail connection portion formed therein or a dovetail projection. This requires the use of a fairly large amount of ceramic which can increase costs. Further, the dovetail interconnection is not generally a tight connection, and additional material must be placed between the dovetail interconnection parts to hold the two together. Thermal expansion and contraction between the parts still can cause separation after continuing operation.

Other methods have been attempted in the past with varying degrees of success and failure.

A need thus arises for means for securing hardened wear-resistant members to an underlying support body, wherein the two members have different coefficients of thermal expansion, with the interconnection between the two providing a secure connection while accommodating differences in expansion and contraction which will occur during use.

### SUMMARY OF THE INVENTION

An object of the present invention is to provide suitable interconnection between a hardened wear-resistant member having a first coefficient of thermal expansion and an underlying support, or body, member, having a different coefficient of thermal expansion, such that the two will remain secured together throughout differing expansion and contraction, which may occur during use.

Another object of the invention is to provide apparatus having a hardened wear-resistant member secured to an underlying body member through a connector which comprises shear compliant material capable of absorbing differing thermal expansion and contraction characteristics between the two members.

Yet another object of the present invention is to provide such apparatus in which a relatively thin wear resistant member may be secured to an underlying support body for the sake of economy, while still maintaining secure interconnection between the two during varying expansion and contraction which may occur.

Yet another object of the invention is to provide a thermal barrier between the wear resistant layer and the support body. This thermal barrier inhibits the transmission of temperature spikes (which might occur in the wear resistant layer during operation) from the wear resistant layer to the support body.

A still further object of the present invention is to provide a method for manufacturing such apparatus in a simple and economical fashion.

### BRIEF DESCRIPTION OF THE DRAWINGS

These and other objects and advantages of the present invention will be apparent from the following detailed description of certain preferred embodiments thereof and from the attached drawings of which:

FIG. 1 is a perspective view of a prior-art device showing, in simplified form, bonded attachment of multiple ceramic elements to an underlying support, or body, member;

FIG. 2 is a cross-sectional view of another prior-art device with a conveyor moving thereover;

FIG. 2A is a simplified cross-sectional view of another prior-art device;

FIG. 3 is a cross-sectional view of apparatus constructed according to one embodiment of the invention;

FIG. 4 is a view similar to FIG. 3, but in exploded fashion, illustrating the component parts thereof;

FIG. 5 is a perspective view exploded in the fashion of FIG. 4;

FIG. 6 is a cross-sectional view of another embodiment of the invention in assembled configuration;

FIG. 7 is a view similar to FIG. 6, with the component parts separated, or exploded; and

FIG. 8 is a perspective view of the exploded elements illustrated in FIG. 7.

### DETAILED DESCRIPTION

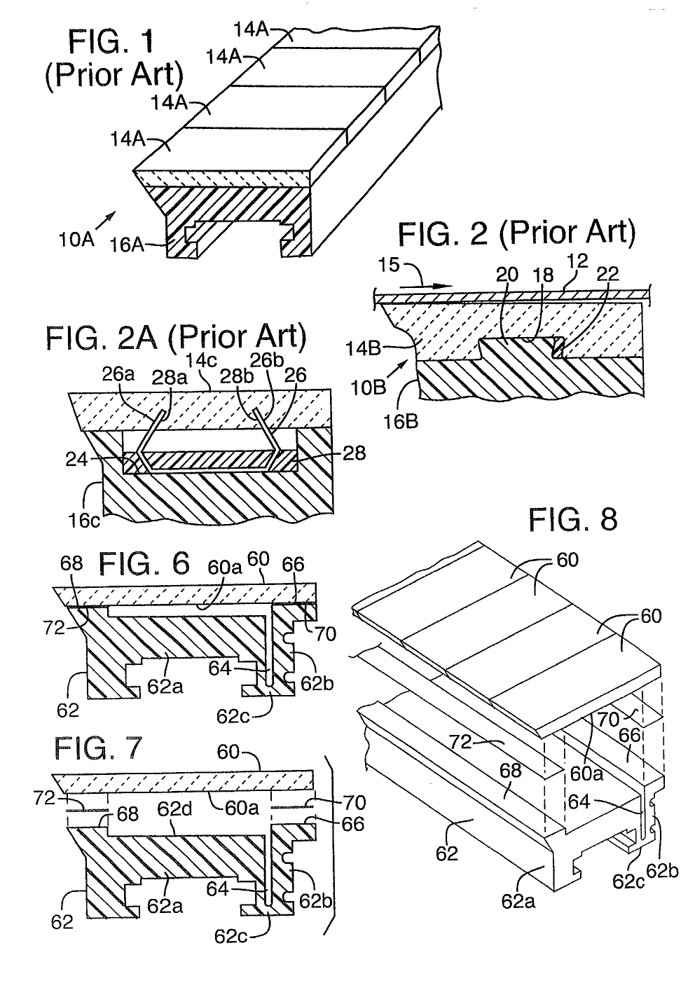

Referring to the drawings, and first more specifically to FIGS. 1 and 2, prior-art devices are illustrated. These illustrate foils, or blades, indicated generally at 10A and 10B which are elongate devices adapted to support a flexible conveyor movable thereover as indicated generally at 12 in FIG. 2. The conveyor illustrated may be a foraminous conveyor such as the wire, or web, of a papermaking machine movable in the direction of arrow 15. The conveyor may carry wood pulp stock or other material over the supports 10A, 10B. In the forms illustrated the devices act to assist in removing water or other liquid from materials on the conveyor.

As is known, and referring still to FIGS. 1 and 2, the apparatus includes a plurality of hardened, wear-resistant, elements 14A, 14B. As best seen in FIG. 1, a plurality of such elements are aligned longitudinally along the elongate device 10A and are disposed in contiguous edge-abutting relationship. These elements often are ceramic and are formed in a desired configuration and secured to an underlying support, or body, member indicated generally at 16A, 16B.

In FIG. 1, the undersides of elements 14A and the top surface of body member 16A are shown to be substantially planar. The elements, or members 14A, are bonded to the upper surface of body 16A by placing an adhesive material therebetween and allowing such to cure.

As mentioned previously, a problem with such construction is that the elements 14A have a first coefficient of thermal expansion which is different from the second coefficient of thermal expansion exhibited by the underlying body member 16A. During use, as the apparatus heats and cools, elements 14A and body member 16A will expand and contract at different rates, thus placing stress on the intermediate adhesive. It has been found that certain wear-resistant elements have a high heat conductance capability. If excess heat is generated during operation such will be conducted through elements 14A. This may cause warpage that misaligns the ceramic elements producing inconsistencies and possible damage in operation of the conveyor moving thereover.

In an attempt to solve this problem, the prior-art construction illustrated in FIG. 2 has been developed. Here ceramic elements 14B have been made thick enough that they can have a dovetail-shaped slot 18 formed on their underside which is adapted to receive a dovetail-shaped projection 20 at the top of body member 16B. In an attempt to permit removal and replacement of individual elements such as 14B in an entire line as illustrated in FIG. 1, the dovetail slot 18 is made wider than dovetail projection 20 and is filled with a bonding adhesive 22.

In this instance, not only is the bonding adhesive subject to stress due to unequal thermal expansion and contraction of the parts, but the ceramic elements must be made thick enough to permit the formation of the dovetail slot while still maintaining sufficient thickness above the slot for integrity of the ceramic member. This can be more expensive than may be desired.

FIG. 2A illustrates, in simplified form, another known device. Here a ceramic element 14C is mounted atop a body member 16C. A channel 24 is formed in the top of body member 16C and a modified U-shaped rod, or wire, 26 is secured at its base in channel 24 by being bedded in epoxy bonding material 28. Rod 26 has upwardly converging arms 26a, 26b. A pair of angularly disposed bores 28a, 28b formed in the underside of ceramic element 14C receive rod arms 26a, 26b in an attempt to retain the ceramic element on the underlying body member.

Problems also occur with a device such as that illustrated in FIG. 2A. First, it relies to a large extent on the holding power of rod ends 26a, 26b in bores 28a, 28b to hold the ceramic element in place on the body member. Further, the ceramic element must be made thicker to accommodate bores 28a, 28b and the bores 28a, 28b formed in the ceramic element can produce stress concentration areas which may result in failure of the ceramic during use.

Applicant has developed apparatus and methods for producing apparatus which does not have the disadvantages of prior devices as set out above.

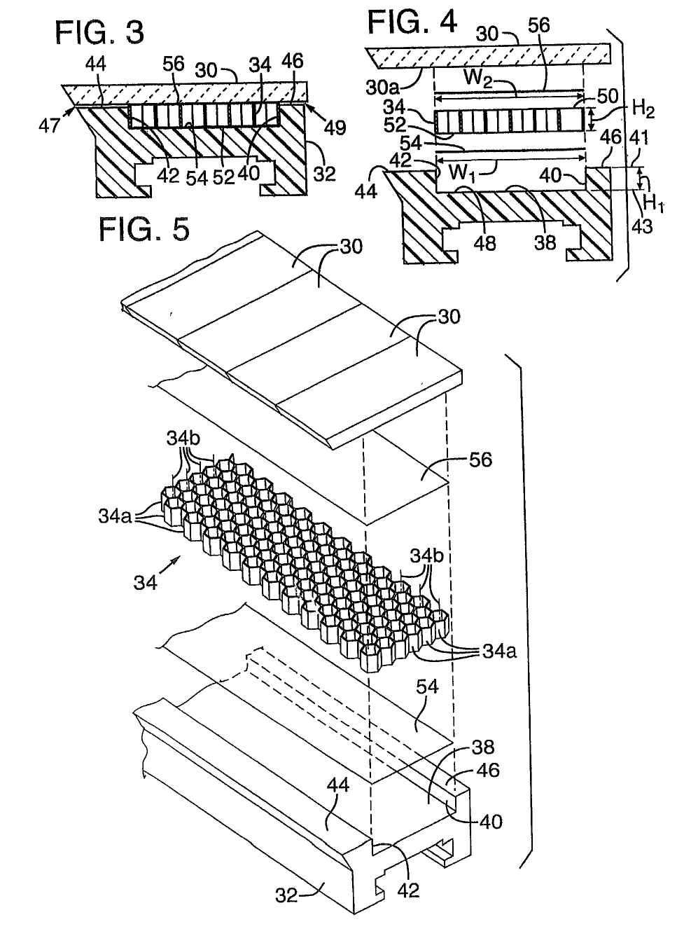

Referring to FIGS. 3-5, a first embodiment is illustrated. Here a hard, wear-resistant, engaging member 30 is mounted atop an underlying supporting, or body, member 32. In the illustrated embodiment the engaging member has a substantially planar lower surface 30a. The engaging member 30 may be made of ceramic or other appropriate hard, wear-resistant material such as metals with a hardened outer surface or coating. The body member 32 may be made of a plastic, such as fiberglass reinforced plastic material or other appropriate supportive material as desired.

The engaging member and body member have different coefficients of thermal expansion and thus will expand and contract at different rates as heating and cooling occurs during operation.

The engaging member and body member have a connector 34 interposed therebetween. The connector comprises shear compliant material which, as will be described in greater detail below, has the ability to accommodate different rates of thermal expansion between the engaging member 30 and the body member 32, while retaining secure attachment in the assembly. In addition, connector 34 provides a degree of thermal insulation between engaging member 30 and body member 32 as will be discussed in greater detail below.

The connector 34 in the illustrated embodiment comprises a layer of honeycomb material as best seen in FIG. 5. The illustrated honeycomb material in constructed, as is known, with a plurality of open cells 34a. Each of the cells has a central axis, as indicated generally at 34b, which, with the honeycomb material positioned as illustrated, extend substantially vertically.

The honeycomb material may be made of stainless steel, aluminum, carbon fiber, or any other material which would provide the necessary characteristics as will be described below to fulfill the necessary functions of the assembly. The structure of the honeycomb is such that it is substantially incompressible under the forces that would be applied vertically thereon as oriented in the combination in FIG. 3, but it does have a degree of lateral shear flexibility, or expansion and contraction capabilities, to accommodate the differing expansion and contraction characteristics of the engaging member and body member. Explaining further, the connector is substantially incompressible in a direction along a first line extending from the engaging member toward the body member, but is somewhat expandable and contractible along a second line extending laterally, at a substantial angle relative to the first line. The connector may expand and contract laterally at different rates at its upper and lower regions to act to absorb the differences in expansion and contraction rates of members 30, 32.

Although the honeycomb material illustrated has substantially hexagonal shape cells, it should be understood that honeycomb material having other configurations of cells also could be used. Such could include cells which are circular, or multi-angular of any desired configuration.

Further, the connector may be made of open cell material, other than honeycomb, capable of providing the necessary vertical support between the engaging member and the body member while permitting expansion and contraction at different rates at its upper and lower regions to act to absorb the differences in expansion and contraction rates of members 30, 32. Such connectors could be provided in a number of structural configurations and material such as carbon fiber, structural foams, engineered plastics or appropriate metals. Further, it will be recognized that the honeycomb material, or other materials used for the connector, provide air spaces between the members 30, 32 which provide a degree of thermal insulation between members 30, 32. Heat which may be produced in members 30 during operation is inhibited from direct transmission to support body 32 by the thermal insulation characteristics of connector 34.

Body member 32 has a channel, or trough, 38, having upright sides 40, 42 at its opposite margins. The channel has a height, or depth, indicated generally at H₁ in FIG. 4. The channel has a width indicated generally at W₁. Upper surface portions 44, 46 at opposite sides of channel 38 lie in a substantially common horizontal plane 41, and upper surface 48 of channel 38 occupies a substantially horizontal plane 43 below plane 41.

The connector 34 has a height, or thickness, indicated generally at H₂ and a width indicated generally at W₂. W₂ is no greater than, and generally may be slightly less than W₁ so that connector 34 may rest easily within channel 38. H₂ is slightly greater than H₁, such that when connector 34 rests in channel 38 its upper surface occupies a plane above the tops of sides 40, 42 and upper surface portions 44, 46.

Connector 34 has substantially planar parallel upper and lower surfaces 50, 52, respectively, which are separated by distance H₂. The term “planar” as used here refers to the ends of the sidewall structure forming the cells occupying common planes, although the majority of the upper and lower surfaces have open-cell structure.

Connector 34 is secured, as by adhesive bonding, to surface 48 of channel 38 by a layer of adhesive 54 interposed therebetween. Similarly, the lower surface portion 30a of ceramic element 30 is secured to the upper surface 50 of connector 34 by a layer of adhesive material 56. When the parts are assembled as illustrated in FIG. 3, connector 34 is securely bonded in channel 38 with the plane of its upper surface slightly above the plane of the upper surface portions 44, 46 of the body member. The underside 30a of ceramic member 30 is adhesively secured to the top of connector 34 and is spaced a distance above upper surface portions 44, 46, thus to produce gaps 47, 49 therebetween. Sides 40, 42 act as retainers, or restraints, to inhibit lateral movement of connector 34 within channel 38.

The structure thus produced provides a shear compliant connector 34 interposed between engaging member 30 and body member 32 to accommodate differing rates of expansion and contraction between the two while maintaining secure attachment therebetween. Explaining further, a conveyor and loads carried over member 30 will be supported thereby. Since the material of connector 34 is substantially incompressible in the vertical direction as illustrated, good firm support will be provided for the conveyor. The engaging member, and thus a conveyor movable thereover, will be maintained at a selected elevation.

Upon thermal expansion and/or contraction of the engaging member and body member, the structure of the connector permits its lower portion to remain bonded to the body member, the upper portion to remain bonded to the ceramic element, and its general structure permits compliance in lateral directions to accommodate different expansion and contraction characteristics.

Explaining further, during operation the parts in the assembly will expand and contract at different rates due to their different coefficients of thermal expansion. Body member 32 may expand and contract at a greater rate than engaging member 30. The structure of the material of connector 34 is such that it is capable of expansion and contraction laterally at different rates adjacent its upper and lower surfaces to absorb the difference in rates of expansion and contraction of the engaging member and the body member. In the illustrated embodiment the open cell structure of the honeycomb material and the resiliency of the material from which is it manufactured provides compliance to shear forces imposed adjacent its upper and lower surfaces by the different rates of thermal expansion of the members such that its lower surface can remain secured to the body member and its upper surface can remain secured to the engaging member throughout use.

Gaps 47, 49 provided between the underside, or lower surface, 30a of the engaging member and upper surface portions 44, 46 allow for vertical expansion and contraction of the body member. Thus upon maximum thermal expansion of the body member it does not contact the engaging member, and thus no force is applied upwardly against the engaging member which would otherwise tend to urge separation of the parts in the assembly.

The upright sidewalls 40, 42, of trough 38 serve to restrict lateral movement of connector 34 to secure it in place in the assembly during use.

The method of manufacturing apparatus as illustrated in FIGS. 3-5 is as follows: body member 32 is produced with the configuration illustrated. It may be produced as a pultrusion from fiberglass reinforced plastic material or other material appropriate to its intended application. A layer of adhesive material 54, appropriate for bonding to the materials of body member 32 and connector 34, which may be a sheet of adhesive, is placed in channel 38. Preformed connector 34 is inserted into channel 38 over adhesive layer 54 and another layer of sheet-like adhesive 56 appropriate for bonding to the materials of connector 34 and elements 30 is laid thereover. Adhesives which may serve to securely bond the connector 34 to the body member 32 and elements 30 to connector 34 are known to those skilled in the art. The ceramic elements 30 then are placed atop adhesive layer 56 and urged into edge abutting relationship as illustrated in FIG. 5. The overall assembly as positioned generally in FIG. 3 then is placed in a fixturing, or clamping, apparatus for curing of the adhesive layers. Where the adhesive used is heat-activated the assembly in its clamped form is subjected to heat, as in a furnace. The adhesive may be a tape-like film of epoxy material which generally is inactive at room temperature. This allows easy placement of the parts for initial assembly and appropriate fixturing. The adhesive is heat-activated and after being heated sufficiently to be activated, it is allowed to cure to produce a firm bond between connector 34 and body member 32 at one side, and between the connector 34 and overlying engaging element, or member, 30 at its other side.

In an alternate method for forming the embodiment illustrated in FIGS. 3-5, different adhesives may be used at 54 and 56. Since maximum heat for the assembly will be experienced by elements 30, adhesive layer 56 must be of a type which is capable of withstanding such higher heat levels and still maintain a consistent and secure bond between elements 30 and connector 34.

Since connector 34 provides a degree of thermal insulation between elements 30 and support body 32, heat experienced by elements 30 will not be fully transmitted through connector 34 to adhesive layer 54. Adhesive layer 54 thus may be of an adhesive which does not have to withstand the high temperatures which would be imposed on adhesive layers 56. Adhesive 54 therefore may be a less expensive adhesive which either does not require heat activation or is activated at a lower temperature than adhesive layer 56.

In assembling a device as thus described, elements 30 and connector 34 may be assembled initially with adhesive layer 56 therebetween. These are held in appropriate fixturing and heated to a sufficiently high temperature to activate adhesive layer 56, with curing then producing bonding between elements 30 and connector 34.

Subsequently, the assembled elements 30 and connector 34 may be connected to support body 32 with adhesive layer 54 between the support body and connector 34. This assembly then may be heated to a temperature sufficient to activate adhesive 54, which may be a temperature much below that required to activate adhesive layer 56. Since support body 32 may be made of a plastic material, this allows the assembly to be connected without imposing on the support body the higher heat levels as are required to activate adhesive layer 56.

In essence, this type of structure permits decoupling of the types of adhesives used at the upper layer 56 and the lower layer 54. Further the decoupling permits a lower temperature to be used to assemble the support body and connector which does not overheat the plastic in the assembly process.

A second embodiment is illustrated in FIGS. 6-8. Here, a plurality of hardened wear-resistant engaging members, or elements, 60 are secured in edge abutting relationship to an underlying body member 62.

Members 60 may be made of ceramic and are similar in configuration to those described previously for elements 30 and also have substantially planar lower surfaces 60a.

Body member 62 is formed of an appropriate material, such as fiberglass reinforced plastic, and is formed as a pultrusion in a desired cross-sectional configuration. Body member 62 has a first, or primary, body portion 62a and a second, or secondary, body portion 62b. For a major portion of the height and length of body member 62 the primary and secondary portions are separated by a channel, or groove, 64. A juncture section 62c at the bottom of body member 62 resiliently joins primary portion 62a and second portion 62b.

A substantially planar upper surface portion 66 of secondary body portion 62b occupies a substantially common horizontal plane with a planar upper surface portion 68 on portion 62a. Surface portions 66, 68 are spaced laterally from each other as illustrated in FIG. 7.

Opposite end portions of ceramic members 60 are adhesively secured to upper surface portions 66, 68 by layers of adhesive, such as those indicated at 70, 72 interposed therebetween. The upper surface region of the body member 62d between surface portions 66, 68 is depressed, such that it does not contact member 60.

The apparatus is assembled as illustrated in FIGS. 7 and 8 by placing strips, or layers, of adhesive 70, 72 atop upper surface portions 66, 68, respectively, and members 60 are laid thereover in edge-abutting relationship. The adhesive may be such that is appropriate to securely bond members 60 to surface portions 66, 68 which may be a heat-activated adhesive or any other appropriate adhesive which could include room temperature curing adhesive. When the parts initially are assembled the adhesive is not cured and the parts may be adjusted in their position as desired. After the parts in the assembly are positioned as desired, clamping fixtures are placed thereon to hold them in place and where the adhesive is heat-activated heat is applied, as by inserting the assembly in an oven to activate the adhesive. The assembly then is allowed to cool, thus curing the adhesive and securely bonding the ceramic elements to the underlying body member.

Since the secondary body member portion 62b is resiliently connected to primary body portion 62a through resilient juncture section 62c, should the ceramic members and body member expand or contract at differing rates during use, such may be absorbed by resilient flexing of the body member parts.

Although preferred embodiments have been described in detail herein, it should be apparent to those skilled in the art that variations and modifications are possible without departing from the spirit of the invention as set out in the following claims:

1. A conveyor support comprising
a body member formed of a first material having a first hardness and a first coefficient of thermal expansion,
a conveyor engaging member supported on said body member, said engaging member formed of a second material having a second hardness greater than said first hardness and a second coefficient of thermal expansion different from said first coefficient of thermal expansion, and
a connector comprising shear compliant third material interposed between said body member and engaging member and having opposed faces, said connector being secured at one of its faces to said body member and adhesively secured at its opposite face to said engaging member, said connector being capable of absorbing differences in thermal expansion between said members during use.

2. The support of claim 1, wherein said shear compliant third material has a degree of flexibility to accommodate differences in thermal expansion between said body member and engaging member.

3. The support of claim 1, wherein third material is substantially incompressible in a direction along a first line extending from said engaging member toward said body member, and is expandable and contractable along a second line extending at a substantial angle relative to said first line.

4. The support of claim 3, wherein said third material is structured to be simultaneously capable of expansion or contraction at a first rate adjacent one face of said connector and at a second rate adjacent the opposite face of said connector.

5. The support of claim 1, wherein said third material comprises a layer of honeycomb material.

6. The support of claim 5, wherein said honeycomb material has a plurality of open cells having central axes and said connector is secured to a surface of said engaging member with central axes of the honeycomb cells disposed substantially perpendicular to said surface of said engaging member.

7. The support of claim 5, wherein said honeycomb material has a plurality of open cells having central axes and said connector is secured to a surface of said body member with central axes of the honeycomb cells disposed substantially perpendicular to said surface of said body member.

8. The support of claim 5, wherein said engaging member has a substantially planar lower surface portion, said honeycomb material has a substantially planar upper surface portion, and adhesive is interposed between said upper and lower surface portions to secure the engaging member to said connector.

9. The support of claim 5, wherein said body member has a substantially planar upper surface portion, said honeycomb material has a substantially planar lower surface portion, and adhesive is interposed between said upper and lower surface portions to secure the body member to said connector.

10. The support of claim 5, wherein said honeycomb material is formed of metal.

11. The support of claim 5, wherein said honeycomb material is formed of a composite.

12. The support of claim 1, wherein said engaging member has a substantially planar lower surface portion, said connector has a substantially planar upper surface portion, and adhesive is interposed between said upper and lower surface portions to secure the engaging member to said connector.

13. The support of claim 1, wherein said engaging member is spaced from said body member and is connected to said body member only through said connector.

14. The support of claim 1, wherein said connector is adhesively secured to said body member.

15. The support of claim 1, wherein said connector has opposed sides extending between its said opposed faces, and said body member comprises side restraints operable to engage said opposed sides of the connector to restrict lateral movement of said connector relative to said body member.

16. The support of claim 15, wherein said connector has a defined thickness, the side restraints have heights less than said defined thickness, and said engaging member is supported atop said connector out of engagement with said body member and said restraints.

17. The support of claim 1, wherein said engaging member is formed of ceramic.

18. The support of claim 1, wherein said body member is formed of plastic material.

19. The support of claim 1, wherein said body member has a channel formed in an upper portion thereof of a defined depth and width, said connector has a thickness greater than said defined depth and a width no greater than said defined width, said connector rests in said channel and projects above the upper surface of the body portion, and said engaging member is supported on the upper surface of the connector out of contact with said body member.

20. The support of claim 19, wherein side margin portions of said channel define restraints to restrict lateral movement of said connector relative to said body member.

21. The support of claim 1, wherein said third material comprises an open cell material.

22. The support of claim 21, wherein said engaging member is secured to one surface of said connector by a first adhesive having first thermal activation characteristics, and the opposite surface of said connector is secured to said body member by a second adhesive having a second thermal activation characteristic different from said first thermal characteristic.

23. The support of claim 22, wherein said open cell material provides thermal insulation between said engaging member and said second adhesive to inhibit transfer of heat from said engaging member to said second adhesive.

24. Apparatus comprising an engaging member formed of a hard wear-resistant first material having a first coefficient of thermal expansion, a body member formed of a second material having a second coefficient of thermal expansion different from said first coefficient of thermal expansion disposed adjacent but spaced from said engaging member, and a connector comprising shear compliant third material interposed between said engaging member and body member and having opposed faces, said connector being secured at one of its faces to said body member and adhesively secured at its opposite face to said engaging member, said connector being capable of absorbing differences in thermal expansion of said body member and engaging member during use.

25. The apparatus of claim 24, wherein said third material is substantially incompressible in a direction along a first line extending from said engaging member toward said body member, and has a degree of expandability and contractability along a second line extending at a substantial angle relative to said first line.

26. The apparatus of claim 25, wherein said third material is structured to be simultaneously capable of expansion or contraction at a first rate adjacent its one face and at a second rate adjacent its opposite face.

27. The apparatus of claim 24, wherein said first material is ceramic.

28. The apparatus of claim 24, wherein said second material is a composite.

29. The apparatus of claim 24, wherein said second material is plastic.

30. The apparatus of claim 24, wherein said third material comprises an open cell material.

31. The apparatus of claim 24, wherein said shear compliant third material comprises honeycomb material.

32. The apparatus of claim 31, wherein said honeycomb material has a plurality of open cells having central axes and said connector is secured to a surface of said engaging member with central axes of the honeycomb cells disposed substantially perpendicular to said surface of said engaging member.

33. The apparatus of claim 31, wherein said honeycomb material has a plurality of open cells having central axes and said connector is secured to a surface of said body member with central axes of the honeycomb cells disposed substantially perpendicular to said surface of said body member.

34. The apparatus of claim 31, wherein said engaging member has a substantially planar lower surface portion, said honeycomb material has a substantially planar upper surface portion, and adhesive is interposed between said upper and lower surface portions to secure the engaging member to said connector.

35. The apparatus of claim 31, wherein said body member has a substantially planar upper surface portion, said honeycomb material has a substantially planar lower surface portion, and adhesive is interposed between said upper and lower surface portions to secure the body member to said connector.

36. The apparatus of claim 31, wherein said honeycomb material is formed of metal.

37. The apparatus of claim 31, wherein said honeycomb material is formed of a composite.

38. The apparatus of claim 24, wherein a portion of said shear compliant third material between its opposite faces has a degree of flexibility to accommodate differences in thermal expansion between said body member and engaging member.

39. A device adapted to be mounted on a papermaking machine under a moving web to engage and support the underside of the web as it passes thereover, the device comprising
a body member formed of a first material having a first hardness and a first coefficient of thermal expansion,
a web engaging member supported on said body member, said engaging member formed of a second material having a second hardness greater than said first hardness and a second coefficient of thermal expansion different from said first coefficient of thermal expansion, and
a connector comprising shear compliant third material interposed between said body member and engaging member and having opposed faces, said connector being secured at one of its faces to said body member and adhesively secured at its opposite face to said engaging member, said connector being capable of absorbing differences in thermal expansion between said members during use.

40. The device of claim 39, wherein a portion of said third material between its opposite faces has a degree of flexibility to accommodate differences in thermal expansion between said body member and engaging member.

41. The device of claim 39, wherein said third material is substantially incompressible in a direction along a first line extending from said engaging member toward said body member, and is expandable and contractable along a second line extending at a substantial angle relative to said first line.

42. The device of claim 41, wherein said third material is structured to be capable a expansion and contraction at a first rate adjacent its one face and at a second rate adjacent its opposite face.

43. The device of claim 39, wherein said connector comprises a layer of honeycomb material.

44. The device of claim 43, wherein said honeycomb material has a plurality of open cells having central axes and said connector is secured to a surface of said engaging member with central axes of the honeycomb cells disposed substantially perpendicular to said surface of said engaging member.

45. The device of claim 43, wherein said honeycomb material has a plurality of open cells having central axes and said connector is secured to a surface of said body member with central axes of the honeycomb cells disposed substantially perpendicular to said surface of said body member.

46. The device of claim 43, wherein said engaging member has a substantially planar lower surface portion, said honeycomb material has a substantially planar upper surface portion, and adhesive is interposed between said upper and lower surface portions to secure the engaging member to said connector.

47. The device of claim 43, wherein said body member has a substantially planar upper surface portion, said honeycomb material has a substantially planar lower surface portion, and adhesive is interposed between said upper and lower surface portions to secure the body member to said connector.

48. The device of claim 43, wherein said honeycomb material is formed of metal.

49. The device of claim 43, wherein said honeycomb material is formed of a composite.

50. The device of claim 39, wherein said engaging member has a substantially planar lower surface portion, said connector has a substantially planar upper surface portion, and adhesive is interposed between said upper and lower surface portions to secure the engaging member to said connector.

51. The device of claim 39, wherein said engaging member is formed of ceramic.

52. The device of claim 39, wherein said third material comprises an open cell material.

53. The device of claim 52, wherein said engaging member is secured to one surface of said connector by a first adhesive having first thermal activation characteristics, and the opposite surface of said connector is secured to said body member by a second adhesive having a second thermal activation characteristic different from said first thermal characteristic.

54. The device of claim 53, wherein said open cell material provides thermal insulation between said engaging member and said second adhesive to inhibit transfer of heat from said engaging member to said second adhesive.

55. A conveyor support comprising
a conveyor engaging member formed of a hard wear-resistant first material having a first coefficient of thermal expansion, and
a body member formed of second material having a second coefficient of thermal expansion different from said first coefficient of thermal expansion, said body member having a primary portion and a secondary portion resiliently connected to said primary portion,
said engaging member being secured at a first region to said primary portion of the body member and at a second region, spaced from said first region, to said secondary portion of the body member, whereby said engaging member remains secured to said body portion throughout unequal expansion and contraction between the body and engaging members during use.

56. The support of claim 55, wherein said engaging member is secured to said primary and secondary portions of said body member by adhesive.

57. The support of claim 55, wherein said body member is a monolithic element composed of material having a degree of flexibility, and said primary and secondary portions are separated by an open space and have upper surfaces to which said engaging member is secured.

58. The support of claim 55, wherein said body member is composed of a composite material.

59. The support of claim 55, wherein said body member is composed of plastic material.

60. Apparatus comprising an engaging member formed of a hard wear-resistant first material having a first coefficient of thermal expansion, and a body member formed of a second material having a second coefficient of thermal expansion different from said first coefficient of thermal expansion, said body member having a primary portion and a secondary portion resiliently connected to said primary portion, said engaging member being secured at a first region to said primary portion of the body member and at a second region, spaced from said first region, to said secondary portion of the body member, whereby said engaging member remains secured to said body portion throughout unequal expansion and contraction between the body and engaging members during use.

61. The apparatus of claim 60, wherein said first material is ceramic.

62. The apparatus of claim 60, wherein said second material is composite.

63. A method for forming a conveyor support having a hard wear-resistant surface over which the conveyor is movable comprising the steps of
providing a body member formed of a material having a first hardness and a first coefficient of thermal expansion, a conveyor engaging member having a second hardness greater than said first hardness and a coefficient of thermal expansion different from said first coefficient of thermal expansion, and a connector comprising shear compliant material,
interposing said connector between said body member and said engaging member,
securing a first side of said connector to said body member, and
securing a second side of said connector opposite said first side to said engaging member using adhesive bonding, with said engaging member spaced from said body member.

64. The method of claim 63, wherein said connector is made from a material having a degree of flexibility to accommodate differences in thermal expansion between said body member and engaging member during use.

65. The method of claim 63, wherein said connector comprises a layer of honeycomb material having a plurality of open cells having central axes and said method comprises the step of securing said connector to said engaging member with said central axes extending substantially perpendicular to said engaging member.

66. The method of claim 63, wherein said connector comprises a layer of honeycomb material having a plurality of open cells having central axes and said connector is secured to said body member with said central axes extending substantially perpendicular to said body member.

67. The method of claim 63, wherein said connector has a substantially planar surface portion, said engaging member has a substantially planar surface portion, and said surface portions of said connector and engaging member have a layer of adhesive material placed therebetween and are pressed against said adhesive to secure said engaging member to said connector.

68. The method of claim 67, wherein said adhesive material is a heat activated adhesive, and heat is applied to activate said adhesive after said connector and engaging member are pressed together.

69. A method for forming a conveyor support having a hard wear-resistant surface over which a conveyor is movable comprising the steps of
providing a body member formed of a material having a first hardness and a first coefficient of thermal expansion, said first body having a first portion and a second portion resiliently connected to said first portion, and providing a conveyor engaging member having a second hardness greater than said first hardness and a coefficient of thermal expansion different from said first coefficient of thermal expansion,
securing a first region of a said engaging member to said first portion of the body member and securing a second region of said engaging member spaced from said first region to said second portion of the body member, whereby said first and second regions of said engaging member remain secured to said first and second portions of said body member respectively throughout unequal expansion and contraction of said members during use.
